(19) United States
(12) Patent Application Publication
(10) Pub. No.: US 2016/0310829 A1
(43) Pub. Date: Oct. 27, 2016

(54) PROJECTION TYPE BILLIARD BALL HITTING INTELLIGENT AUXILIARY SYSTEM AND METHOD

(71) Applicants: Bing QIAO, Hebei (CN); Jiaoang LI, Liaoning (CN)

(72) Inventors: Bing QIAO, Hebei (CN); Jiaoang LI, Liaoning (CN)

(21) Appl. No.: 15/104,985

(22) PCT Filed: May 29, 2015
(86) PCT No.: PCT/CN2015/080151

§ 371 Date: Jun. 16, 2016

(30) Foreign Application Priority Data
Jul. 2, 2014 (CN) 201410312463.1

(51) Int. Cl. A63D 15/00; H04N 5/33; G06T 7/20; G03B 29/00; G06T 7/00

(52) U.S. Cl. CPC A63D 15/00; G03B 29/00; G06T 7/0044; G06T 7/0051; G06T 7/20; H04N 5/332; G06T 2207/30241; G06T 2207/10048

(57) ABSTRACT

A projection type billiard ball hitting intelligent auxiliary system and method. The system comprises an image capture device (7), a projection device (6) and a computer (3). The signal output end of the image capture device (7) is connected to the input end of the computer (3). The input end of the projection device (6) is connected to the output end of the computer (3) and controlled by the computer (3). A hollow billiard illuminating lamp (4) and an infrared light supplementary lamp (5) are further provided. The method includes that a billiard environmental model is built in the computer (3). When billiard balls (9) are static, the images of the billiard balls (9) on a billiard table (8) are captured, and the coordinates of the billiard balls (9) are obtained. When a user bends over to aim a billiard rod (10) at a cue ball, the coordinates of two end points and the hitting direction of the billiard rod (10) are captured in real time, and the first ball which the rod head of the billiard rod (10) points to serves as the cue ball. According to the coordinates of the billiard balls (9), to-be-operated tracks of the cue ball and the other target balls are calculated in cooperation with the preset hitting force of the billiard rod (10) and the angles between the hitting points and the horizontal direction of the billiard rod (10). The to-be-operated tracks of the cue ball and the other balls are projected on the billiard table (8).

### BACKGROUND OF THE INVENTION

The invention herein generally relates to software system of the computer and projection technology, applied for the sports assist in playing billiards including 8-ball pool, 9-ball pool and Snooker for all kinds and levels of billiards lovers, and particularly to the intelligent assist system and method for hitting of projection billiards.

In the billiards sports, the accuracy of hitting is the first factor to make the difference between winning and losing, and control of the cue ball takes the second.

At present there are several kinds of method below to improve the accuracy of hitting:

1. Take the point where the extension of the line connecting the center of the object ball and the center of the object pocket mouth is intersected with the edge of the object ball as the hitting point of the cue ball and the object ball all by imagination, and then hit the billiards with the cue. The shortcoming of the method above is that: the billiards player cannot find the right hitting point until he's had a great deal of repetitive training, while there's not a very clear and real hitting line in the mind of beginners, and the right hitting point of the object ball at certain position is actually not the intersection point above mentioned.

2. It's based on some assistance such as the aiming rule and the position sight, etc on the billiards table(for example, the training sight of the pocket game-91223689.2). This assistance is not very satisfactory as some will affect the route of the cue ball and some will affect the sight and attention of players.

3. Some laser assist device for aiming the billiards(for example, a laser cue-200820202827.0), of which the shortcoming is that: a. As the laser travels in straight lines while the movement track is curve sometimes in the process of hitting the billiards, it is no practical for the laser to achieve this function; b. It's not easy for the laser to prompt the rebound track of the billiards, and the rebound track can be just simply simulated as one of which the incident angle is equal to the emergence angle even if it's prompted. While the rebound track of the billiards is usually one that he incident angle is not equal to the emergence angle; c. The cue will have a certain weight after this device is installed on it. Players can use it during training, but no during the race, because it will greatly affect the user's power control of hitting and feeling of touching due to the weight differences.

For the training on the control of the cue ball, at this stage players judge and control the cue ball mainly based on teaching by the coach's example as well as verbal instruction, along with a great deal of repetitive practice. As the movement track of the billiards is affected by many aspects, including friction force, elastic force, hitting strength, hitting position and force method, neither beginners nor skilled players can point out exactly the track the billiards to run for every hit.

### BRIEF SUMMARY OF THE INVENTION

In order to overcome the drawbacks of the prior art, an objective of the present invention is to provide an intelligent assist system and method for hitting of the billiards, which displays all the real-time movement tracks prejudged on the billiards table according to the different way of controlling the cue.

In order to achieve the above objective, the present invention proposes the following solutions: an intelligent projection assist system comprising the image acquisition device, the projection device and the computer, where the signal output end of the image acquisition device is connected to the input end of the computer, and the input end of projection device is connected to the output end of the computer and controlled by the computer and hollow billiards lights and infrared light supplement lamps are also equipped;

The lens of the image acquisition device where a visible light filter is added, and of which the head end is aimed at the hollow part center of the hollow billiards light and no under the bottom of the hollow billiards light configured for capturing the image information of the billiards table, the billiards and the cue;

The infrared light supplement lamp fixed on the hollow billiards light, of which lighting end is as high as the bottom of the hollow billiards light configured for infrared lighting on the billiards table and filtering the visible light in the image acquisition device;

The computer used for acquiring the image information captured by the image acquisition device shone in the light of the infrared light supplement lamp, getting the track information of the billiards to run according to the ordinate of the billiards, that of the two ends of the cue, the hitting direction, hitting strength and the hitting angel received, and projecting the track information of the billiards with images to the corresponding position of the billiards table through the projection device;

The hollow billiards light is at the top of the billiards table, so that the image acquisition device is right in front of the center of the billiards table.

The image acquisition device is fixed with the hanger of the image acquisition device.

The projection device and the computer are both installed at the bottom of the projection hanger and hung to the side of the hollow billiards light.

The computer is specifically used for:

acquiring the billiards coordinate, the coordinate of the cue and the hitting direction according to the image information captured by the image acquisition device; then

figuring out the track of the cue ball and other object balls to run according to default data on the coordinate of the billiards, the hitting strength of the cue, the hitting point and the angel of the cue; and/or

taking the position without a ball on the billiards table designated by the user as the end point of the track the cue ball will run, and figuring out the hitting strength, the hitting point and the cue angel with which the cue ball reaches the designated ending, according to the coordinate of the cue, that of the object ball and of the cue ball as well as the end-point ordinate of the track where the cue ball will run; and/or

taking the certain billiards designated by the user on the billiards table as the next object ball to hit, and figuring out the position where the cue ball runs and hits the next object ball according to the coordinate of the cue, that of the object ball and of the cue ball as well as the coordinate of the next object ball to hit.

A method of the intelligent projection assist for hitting the billiards, comprising:

establishing the billiards environmental model in the computer and simulate the movement track after hit of the cue ball, the track of the object ball hit directly/indirectly by the cue ball and the rebound track of the object ball;

capturing the image of billiards on the billiards table and acquire the billiards coordinate when the billiards is still;

capturing the real-time coordinate of the two ends of the cue and hitting directions when the user bends to aim the cue ball with the cue, and regarding the first ball pointed by the tip of the cue as the cue ball;

figuring out the track of the cue ball and other object balls to run according to the coordinate of the billiards, as well as the preset hitting strength, the hitting point and the angel of the cue; and/or

taking the position without a ball on the billiards table designated by the user as the end point of the track the cue ball will run, and figuring out the hitting strength, the hitting point, the cue angel and the running track with which the cue ball reaches the designated ending, according to the coordinate of the cue, that of the object ball and of the cue ball as well as the end-point ordinate of the track where the cue ball will run; and/or

taking the certain billiards designated by the user on the billiards table as the next object ball to hit, and figuring out the position where the cue ball runs and hits the next object ball and its running track according to the coordinate of the cue, that of the object ball and of the cue ball as well as the coordinate of the next object ball to hit;

projecting the track with which the billiards will run to the billiards table with the projection device.

The billiards environmental model is the parameters as follows: the length and width of the billiards table, friction coefficient of the woolen table-board, shape data of the pocket mouth, cushion elasticity, friction coefficient among billiards, cushion shape, cushion height, tip size of the cue, friction coefficient between the tip of the cue and the billiards, diameter of the billiards, quality of the billiards, billiards elasticity on the billiards table, and project the physics relationship according to the hitting strength, hitting point and the angel set by the user.

The billiards coordinate, the coordinate of the cue and the hitting direction compare the current image and the background image with OpenCV by C Language, or acquire the current image and the previous frame.

The billiards coordinate is acquired by the means below: the image acquisition device captures an image as the background when there's no billiards on the billiards; compare the image that the billiards is disposed on the billiards table or the billiards is still after it's hit with the background image and get the coordinate of the billiards position;

The coordinate of the two ends of the cue is acquired by the means below: the image acquisition device captures an image as the background after the billiards on the table is still, and captures a image with the cue when the user is aiming with the cue, and the image that the user is aiming with the cue is acquired after these two images are compared; then analyze the part of the image with the rectangular shape character of the cue, so that the position coordinate of both the start and the end on one part of the cue is acquired;

The hitting direction of the cue is acquired by the means below: figure out the angle between the horizontal direction and the cue with the formula θ=arctan((y2−y1)/(x2−x1)) according to the coordinate of the start and the end of the billiards(x1, y1),(x2, y2); then analyze the image of the cue, where the thinner end pointed to the billiards is the tip and the other end is the butt; determine the hitting direction of the cue in the image according to the angle between the horizontal direction and the cue and the analysis result of the tip and the butt.

The computer keeps the track of the cue ball and other object balls to run constant and projects it on the billiards table through the projection device until the position coordinate of the billiards collected by the image acquisition device has some change, if there's no change of the position of the cue collected by the image acquisition device in the preset time when the user bends to aim the cue ball with the cue.

The method also comprising: recording and storing the coordinate of each billiards in the computer while the billiards is still, and projecting the coordinate of the billiards record to the billiards table under the condition of external trigger after the position of the billiards changes.

Therefore, the following advantages and good effects of the present invention become apparent:

1. When the user is aiming with the cue, the real-time aiming line and the movement track of the billiards will be projected on the billiards table for assisting the user to hit, which is convenient and visible.

2. As the line projected on the billiards table is just the shadow, it won't affect the travel of the billiards, not like the previous assistance which shall be disposed to aim, and it won't damage the woolen table-board as no line is chalked on it; moreover, the infrared light supplement lamp is used for not only lighting the billiards table, but also reducing the interference of visible light such as the projection when the image acquisition device is collecting the image on the billiards table.

3. Since the hitting point and the rebound point of the billiards as well as the track of the cue ball and the object ball are all projected on the billiards table, they are no longer judged by the user just based on imaginations and experience so as to shorten the training schedule.

4. When the user is playing billiards, there will be an image or voice at all times to prompt the hitting strength, the hitting point and the cue angle, which is just like the real-time guide by a personal trainer. Thus the user's level of the billiards will be improved quickly.

### BRIEF DESCRIPTION OF THE DRAWINGS

FIG. 1 is a structural diagram of the system provided in accordance with the present invention;

Thereinto, 1. projection hanger, 2. hanger of the image acquisition device, 3. Computer, 4. Hollow billiards light, 5. infrared light supplement lamp, 6. Projection device, 7. Image acquisition device, 8. Billiard table, 9. Billiards, 10. Cue.

FIG. 2 is a diagram of the angel between the hitting point and the horizontal direction of the cue.

### DETAILED DESCRIPTION OF THE INVENTION

The present invention will now be described more specifically with reference to the drawings and the following embodiments.

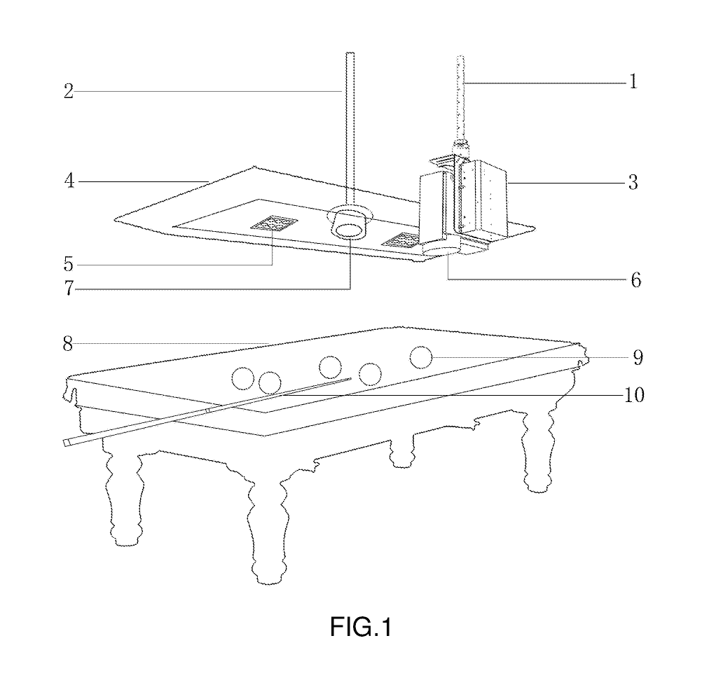

Referring to FIG. 1, the image acquisition device 7, the projection device 6 and the computer 3 are provided. The signal output end of the image acquisition device 7 is connected to the input end of the computer 3, and the input end of projection device 6 is connected to the output end of the computer 3 and controlled by the computer 3, and hollow billiards lights 4 and the infrared light supplement lamps 5 are also equipped; the head end of the image acquisition device 7 is aimed at the hollow part center of the hollow billiards light 4 and no under the bottom of the hollow billiards light 4 configured for capturing the image information of the billiards table 8, the billiards 9 and the cue 10; The infrared light supplement lamp 5 are fixed on the hollow billiards light 4, of which lighting end is as high as the bottom of the hollow billiards light 4 configured for infrared lighting on the billiards table 8 and filtering the visible light in the image acquisition device 7; The computer 3 is used for acquiring the image information captured by the image acquisition device 7 shone in the light of the infrared light supplement lamp 5, getting the track information of the billiards to run according to the coordinate of the billiards, that of the two ends of the cue, the hitting direction, hitting strength and the hitting angel received, and projecting the track information of the billiards with images to the corresponding position of the billiards table 7 through the projection device 6; The hollow billiards light 4 is disposed at the top of the billiards table 8, so that the image acquisition device 7 is right in front of the center of the billiards table 8. The image acquisition device 7 is fixed by the hanger of the image acquisition device 2. The projection device 6 and the computer 3 are both installed at the bottom of the projection hanger 1 and hung to the side of the hollow billiards light 4.

Embodiments of the invention are as follows:

Establish the billiards environmental model with the computer. It's including the length and width of the billiards table, friction coefficient of the woolen table-board, shape data of the pocket mouth, cushion elasticity, friction coefficient among billiards, cushion shape, cushion height, tip size of the cue, friction coefficient between the tip of the cue and the billiards, diameter of the billiards, quality of the billiards, billiards elasticity on the billiards table, etc. Then simulate the track of the cue ball and the object ball based on the principle of physics according to the hitting strength, the hitting point and the cue angel set by the user. For the process and algorithm therein please refer to “Chapter 2 Physical analysis of billiards” as well as “Section 4.1 Movement simulation of the cue ball” and “Section 4.2 Movement simulation of the object ball” of “Chapter 4 Billiards animations based on physics” in the paper “Billiards Animation Based on Physics”

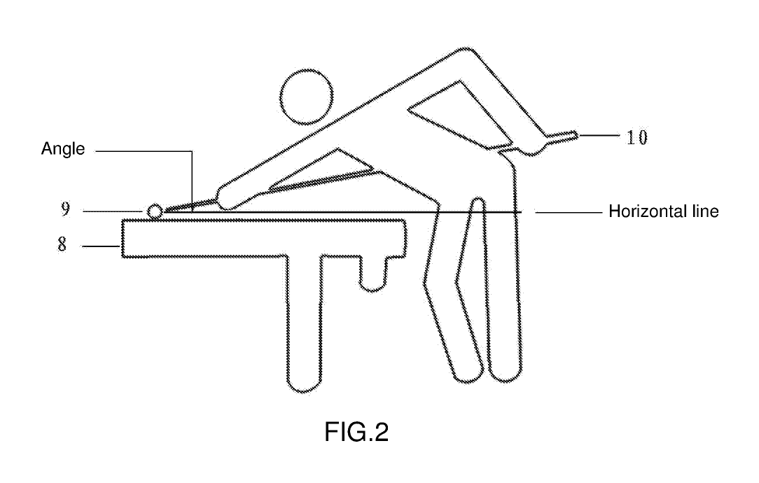

Establish the simulation program of the billiards movement with the computer. Simulate the track after hit of the cue ball, the track of the object ball hit directly/indirectly by the cue ball and the rebound track of the object ball in terms of laws of physics according to the hitting data of the cue ball, that is, the hitting direction of the cue, the angle between the cue and the horizontal direction(as shown in FIG. 2), the hitting point and the hitting strength, etc. Meanwhile establish the program interface of the cue ball's hitting data.

Capture the image of the billiards on the table with the image acquisition device, and analyze the prepared position of the billiards through the computer, then pass the position coordinate of the billiards to the simulation program of the billiards movement.

The real-time cue action of the user is captured by the image acquisition device when he bends to aim the cue ball with the cue. The position of the cue and the hitting direction will be analyzed by the computer, and according to the position coordinate of the billiards acquired, the first ball which the tip of the cue is pointed to is regarded as the cue ball. Then default data of hitting (the hitting strength of the cue is medium, the hitting point is the center point of the cue ball and the angel between the cue and the horizontal direction is 0) is passed to the simulation program of the billiards track, and the simulation program will analyze and figure out the track the cue and other object ball will run according to the data of the billiards coordinate.

The computer controls the projection device to project the real-time tracks on the billiards table. Then the user can hit the ball according to the track of the cue ball projected on the billiards table for the purpose of hitting the object ball into the pocket and controlling the cue ball to travel to the ideal position.

Take the billiards in the hitting direction of the cue and nearest to the tip of the cue as the cue ball to be hit, then figure out the tracks of the cue ball and other object balls to run by the computer in terms of default values that hitting strength is medium, the hitting point is the center point of the cue ball and the angel between the cue and the horizontal direction is 0. Project these prejudged tracks on the billiards table by the projection device. The user can hit the billiards in the way that hitting strength is medium, the hitting point is the center point of the cue ball and the angel between the cue and the horizontal direction is 0, according to these tracks projected on the billiards table. And he also can properly adjust the hitting strength, the hitting point and the angle between the cue and the horizontal direction when hitting, so as to control the cue ball more in line with his needs.

The route of the billiards on the billiards table can also be adjusted more accurately in the way of hitting the user wants through the computer. The specific method is as follows: when the user bends to aim with the cue, it's regarded that he ends his aiming if the cue isn't shaken in a certain time(with N seconds, N<=3). Then at this time the tracks of the cue ball and other object balls to run figured out by the computer according to the three default data of hitting , that is, the hitting strength of the cue is medium, the hitting point is the center point of the cue ball and the angel between the cue and the horizontal direction is 0 will be projected stably to the billiards table by the projection device without any change. Then the user can stand up and control the computer by himself, and change the hitting strength, the hitting point and the angel between the cue and the horizontal direction according to his requirements, to make the track of the billiards reach the ideal track he needs. The user bends again and hits the cue ball with the cue according to the hitting strength, the hitting point and the angel between the cue and the horizontal direction set by himself to make the real track of the cue ball and the object ball reach the ideal state.

The computer will connect the coordinate of the object ball respectively with the 6 pockets in lines, and analyze whether there's other ball blocking the hitting route of the object ball in each line. If all routes of 6 pockets are blocked, the computer will remind the user that the intelligent hitting prompt cannot be performed. If one or some pockets of them is not blocked, the shortest route therein will be selected as the preferred route of the hitting prompt, and its corresponding pocket will be regarded as the object pocket. Then connect the object pocket with the object ball in line, select a point in the extension direction of the object ball which is neither attached to the cushion nor too close to the object ball, and take the position coordinate of this point as the end coordinate of the track the cue ball will run. Meanwhile, figure out the hitting strength of the cue, the hitting point and the angel between the cue and the horizontal direction that is required for traveling to this position through the computer, and assist the user to hit with the voice prompt of the computer.

After the track is fixed, the user can not only play billiards on the fixed track, but also stand and observe the track the cue ball and the object ball will run. At this time the computer can also be controlled to change the hitting strength of the cue, the hitting point of the cue ball and the angle between the cue and the horizontal direction so as to change the track of the cue ball and the object ball until it's satisfactory. Then the user can hit the cue ball with the cue according to the hitting strength, the hitting point and the angle between the cue and the horizontal direction adjusted by himself, so that the cue ball and the object ball can travel on the ideal track of simulation.

The computer can also be controlled in advance to set the hitting strength of the cue, the hitting point of the cue ball and the angle between the cue and the horizontal direction. Then the computer will simulate the tracks of the cue ball and the object ball according to these data and control the projection device to project it on the billiards table. Later the user hits the cue ball with the real cue according to the hitting strength, the hitting point and the angle between the cue and the horizontal direction adjusted by himself, so that the cue ball and the object ball can travel on the ideal track of simulation.

The computer can be controlled to designate the position without a ball on the billiards table as the end of the track that the cue ball will run. Then according to the position information of the user's cue, the cue ball to hit and the object ball which the cue ball will hit into the pocket captured by the image acquisition device, the computer program will analyze intelligently what hitting strength, hitting point and angle between the cue and the horizontal direction will make the track of the cue ball reach the ideal object position of the user. At last it'll prompt the user with voice and images, and project the track the billiards will run on the billiards table so as to assist the user to hit billiards.

Moreover, the computer can be controlled to designate a certain billiards(ball B) on the billiards table as the next object ball to hit. The computer program analyzes intelligently the position information of the user's cue, the cue ball to hit and the object ball (ball A) the cue ball will hit into the pocket captured by the image acquisition device. And the computer program will analyze intelligently what hitting strength, hitting point and angle between the cue and the horizontal direction it is to make the cue ball hit to the proper position of ball B. At last it'll prompt the user with voice and images, and project the track the billiards will run on the billiards table so as to assist the user to hit billiards.

After hitting, the user can control the computer to repeat the hitting process if the effect of hitting is not very good. That is, the computer control the projection device to project the image which the previous billiards position of hitting is in on the billiards table, the user reset the billiards at the position of the projection and then hit them again.

Simulation animation of the billiards movement can be produced by the computer according to the billiards track intelligently analyzed, and displayed on the billiards table before the user is hitting. Thus the user can watch the image the billiards will run more directly and vividly.

What is claimed is:

1. An intelligent projection assist system for hitting of the billiards, comprising: The computer (3),image acquisition device (7) of which the signal output end is connected to the input end of the computer (3), and projection device (6) of which the input end is connected to the output end of the computer (3) and controlled by the computer (3), wherein hollow billiards light (4) and the infrared light supplement lamp (5) are also equipped; The lens of the image acquisition device (7) where a visible light filter is added , and of which the head end is aimed at the hollow part center of the hollow billiards light (4) and no under the bottom of the hollow billiards light (4) configured for capturing the image information of the billiards table (8), the billiards (9) and the cue (10); The infrared light supplement lamp (5) are fixed on the hollow billiards light (4), of which lighting end is as high as the bottom of the hollow billiards light (4) configured for infrared lighting on the billiards table (8) and filtering the visible light in the image acquisition device (7); The computer (3) are used for acquiring the image information captured by the image acquisition device (7) shone in the light of the infrared light supplement lamp (5), getting the track information of the billiards to run according to the coordinate of the billiards, that of the two ends of the cue, the hitting direction, hitting strength and the hitting angel received, and projecting the track information of the billiards with images to the corresponding position of the billiards table (7) through the projection device (6); The hollow billiards light(4) is at the top of the billiards table (8), so that the image acquisition device (7) is right in front of the center of the billiards table (8).

2. The system of claim 1, wherein the image acquisition device (7) is fixed by the hanger of the image acquisition device (2).

3. The system of claim 1, wherein the projection device (6) and the computer (3) are both installed at the bottom of the projection hanger (1) and hung to the side of the hollow billiards light (4).

4. The system of claim 1, wherein the computer (3) is specifically used for: acquiring the coordinate of the billiards (9) and that of the cue (10) as well as the hitting direction according to the image information captured by the image acquisition device (7); then figuring out the track of the cue ball and other object balls to run according to the default data on the coordinate of the billiards (9), as well as the hitting strength, hitting point, the angle between the hitting point and the horizontal direction of the cue; and/or taking the position without a ball on the billiards table designated by the user as the end point of the track the cue ball will run, and figuring out the hitting strength, hitting point and the cue angel according to the coordinate of the cue, that of the object ball and of the cue ball as well as the end-point ordinate of the track where the cue ball will run; and/or taking the certain billiards designated by the user on the billiards table as the next object ball to hit, and figuring out the position where the cue ball runs and hits the next object ball according to the coordinate of the cue, that of the object ball and of the cue ball as well as the ordinate of the next object ball to hit.

5. An intelligent projection assist method for hitting of the billiards, capitalized in the following steps: establish the billiards environmental model in the computer (3) and simulate the movement track after hit of the cue ball, the track of the object ball hit directly/indirectly by the cue ball and the rebound track of the object ball; capture the image of billiards (9) on the billiards table (3) and acquire the billiards (9) coordinate when the billiards (9) is still; capture the real-time coordinate of the two ends of the cue (10) and hitting directions when the user bends to aim the cue ball with the cue, and regard the first ball pointed by the tip of the cue (10) as the cue ball; figure out the track of the cue ball and other object balls to run according to the coordinate of the billiards (9), as well as the preset hitting strength, hitting point and the angel of the cue (10); and/or take the position without a ball on the billiards table designated by the user as the end point of the track the cue ball will run, and figure out the hitting strength, hitting point, the cue angel and the running track with which the cue ball reaches the designated ending, according to the coordinate of the cue, that of the object ball and of the cue ball as well as the end-point ordinate of the track where the cue ball will run; and/or take the certain billiards designated by the user on the billiards table as the next object ball to hit, and figure out the position where the cue ball runs and hits the next object ball and its running track according to the coordinate of the cue, that of the object ball and of the cue ball as well as the coordinate of the next object ball to hit; project the track with which the billiards will run to the billiards table (8) with the projection device (6).

6. The method of claim 5, wherein the billiards environmental model is the parameters as follows: the length and width of the billiards table, friction coefficient of the woolen table-board, shape data of the pocket mouth, cushion elasticity, friction coefficient among billiards, cushion shape, cushion height, tip size of the cue, friction coefficient between the tip of the cue and the billiards, diameter of the billiards, quality of the billiards, billiards elasticity on the billiards table, and project the physics relationship according to the hitting strength, hitting point and the angel set by the user.

7. The method of claim 5, wherein the billiards coordinate, the coordinate of the cue and the hitting direction compare the current image and the background image with OpenCV by C Language, or acquire the current image and the previous frame.

8. The method of claim 5, wherein the billiards coordinate is acquired by the means below: the image acquisition device captures an image as the background when there's no billiards on the billiards; compare the image that the billiards is disposed on the billiards table or the billiards is still after it's hit with the background image and get the coordinate of the billiards position;
The coordinate of the two ends of the cue is acquired by the means below: the image acquisition device captures an image as the background after the billiards on the table is still, and captures a image with the cue when the user is aiming with the cue, and the image that the user is aiming with the cue is acquired after these two images are compared; then analyze the part of the image with the rectangular shape character of the cue, so that the position coordinate of both the start and the end on one part of the cue is acquired;
The hitting direction of the cue is acquired by the means below: figure out the angle between the horizontal direction and the cue with the formula θ=arctan ((y2−y1)/(x2−x1)) according to the coordinate of the start and the end of the billiards (x1,y1),(x2, y2); then analyze the image of the cue, where the thinner end pointed to the billiards is the tip and the other end is the butt; determine the hitting direction of the cue in the image according to the angle between the horizontal direction and the cue and the analysis result of the tip and the butt.

9. The method of claim 5, wherein the computer (3) keeps the track of the cue ball and other object balls to run constant and projects it on the billiards table (8) through the projection device (6) until the position coordinate of the billiards (9) collected by the image acquisition device (7) has some change, if there's no change of the position of the cue (10) collected by the image acquisition device (7) in the preset time when the user bends to aim the cue ball with the cue (10).

10. The method of claim 5, also comprising: recording and storing the coordinate of each billiards in the computer (3) while the billiards is still, and projecting the coordinate of the billiards record to the billiards table under the condition of external trigger after the position of the billiards changes.
